(19) United States
(12) Patent Application Publication
(10) Pub. No.: US 2026/0058242 A1
(43) Pub. Date: Feb. 26, 2026

(54) POWER STORAGE CELL

(71) Applicant: TOYOTA JIDOSHA KABUSHIKI KAISHA, Toyota-shi (JP)

(72) Inventor: Koji NAKANISHI, Konan-shi (JP)

(73) Assignee: TOYOTA JIDOSHA KABUSHIKI KAISHA, Toyota-shi (JP)

(21) Appl. No.: 19/204,820

(22) Filed: May 12, 2025

(30) Foreign Application Priority Data
Aug. 20, 2024 (JP) 2024-139019

(51) Int. Cl. H01M 10/653; H01M 10/613; H01M 10/647; H01M 10/6551; H01M 50/103; H01M 50/209; H01M 50/30

(52) U.S. Cl. CPC H01M 10/653; H01M 10/613; H01M 10/647; H01M 10/6551; H01M 50/30; H01M 50/103; H01M 50/209; H01M 2200/20

(57) ABSTRACT

A power storage cell includes: an electrode body; a cell case housing the electrode body; and a heat conductive film provided on an outer surface of the cell case. The outer surface includes a facing surface that faces a cooler that is externally provided. The heat conductive film is provided on the facing surface and has insulation and elasticity.

### CROSS-REFERENCE TO RELATED APPLICATION

This application claims priority to Japanese Patent Application No. 2024-139019 filed on Aug. 20, 2024. The disclosure of the above-identified application, including the specification, drawings, and claims, is incorporated by reference herein in its entirety.

### BACKGROUND

### 1. Technical Field

The present disclosure relates to a power storage cell.

### 2. Description of Related Art

For example, Japanese Unexamined Patent Application Publication No. 2018-037343 (JP 2018-037343 A) discloses a power storage apparatus including a power storage cell and a cooler. An insulating film is externally attached onto a surface of the power storage cell. The power storage cell is arranged on the cooler via the insulating film and a heat conductive material.

### SUMMARY

The power storage cell of the power storage apparatus disclosed in JP 2018-037343 A is arranged on the cooler via the insulating film and the heat conductive material. When the power storage cell expands or contracts, wrinkles or kinks on the insulating film cause air spaces at the interface between the power storage cell and the insulating film. As a result, heat conduction between the power storage cell and the cooler is disturbed.

The present disclosure is devised in order to solve the aforementioned problem, and an object thereof is to provide a power storage apparatus capable of restraining heat conduction between a power storage cell and a cooler from being disturbed.

There is provided a power storage cell according to a first aspect of the present disclosure, the power storage cell including: an electrode body; a cell case housing the electrode body; and a heat conductive film provided on an outer surface of the cell case, wherein: the outer surface includes a facing surface that faces a cooler that is externally provided; and the heat conductive film is provided on the facing surface and has insulation and elasticity.

An elasticity of the heat conductive film of the power storage cell according to the first aspect of the present disclosure may be indicated as 5 points or more with a type C durometer and as 50 points or less with a type A durometer, and a dielectric breakdown voltage of the heat conductive film may be not less than 5 kV/mm and not more than 30 kV/mm.

The elasticity of the heat conductive film of the power storage cell according to the first aspect of the present disclosure may contain an insulating filler material.

The power storage cell according to the first aspect of the present disclosure may be housed in a power storage apparatus, the power storage apparatus may include a housing case, and the cooler, the housing case may include an upper cover, and a lower case, the lower case may have a bottom plate, and a wall portion provided to stand from the bottom plate in a first direction, the bottom plate may support the power storage cell in the first direction, and the cooler may be provided on the bottom plate and be disposed on an opposite side of the bottom plate from the power storage cell in the first direction.

The power storage cell according to the first aspect of the present disclosure may further include: an exhaust valve; and an external terminal, the outer surface may have an end surface disposed to be spaced from the facing surface in the first direction, and a peripheral surface connecting the facing surface and the end surface, the peripheral surface may have a first lateral surface, and a second lateral surface disposed to be spaced from the first lateral surface in a second direction intersecting the first direction, the exhaust valve may be provided on the outer surface, the external terminal may be provided on at least one of the first lateral surface and the second lateral surface, and the heat conductive film may be provided except on the external terminal and the exhaust valve.

According to the power storage cell according to the present disclosure, heat conduction between the power storage cell and the cooler can be restrained from being disturbed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a lateral view showing a vehicle that a power storage apparatus in an embodiment of the present disclosure is mounted on;

FIG. 2 is an exploded perspective view of the power storage apparatus in an embodiment of the present disclosure;

FIG. 3 is a perspective view of a power storage cell in an embodiment of the present disclosure;

FIG. 4 is a sectional view as the IV-IV section in FIG. 1; and

FIG. 5 is a perspective view showing a modification of the power storage cell in an embodiment of the present disclosure.

### DETAILED DESCRIPTION OF EMBODIMENTS

Hereafter, embodiments of the present disclosure will be described in detail with reference to the drawings. The like or corresponding portions in drawings are given the like signs, and their description is not repeated.

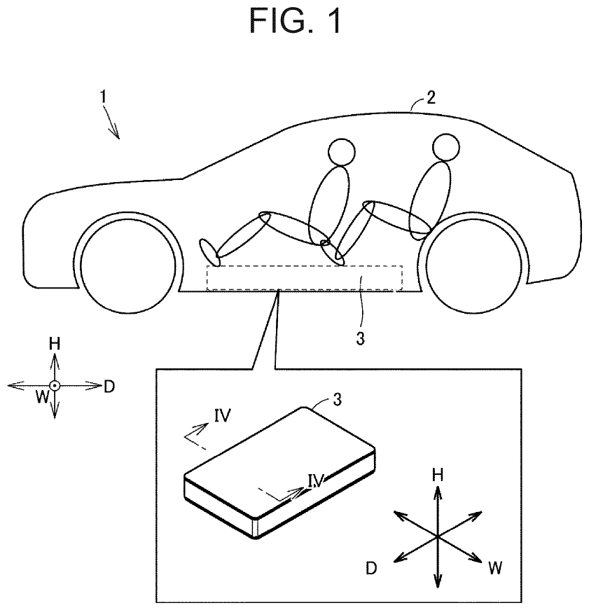

FIG. 1 is a lateral view schematically showing a vehicle that a power storage apparatus according to the present embodiment is mounted on. Notably, a height direction H shown in FIG. 1 denotes a height direction of a vehicle 1. A width direction W denotes a width direction of the vehicle 1. A front-rear direction D denotes a front-rear direction of the vehicle 1. Notably, the height direction H and the width direction W are examples of a “first direction” and a “second direction” of the present disclosure, respectively.

The vehicle 1 includes a body 2 and a power storage apparatus 3. Examples of the vehicle 1 include a plug-in hybrid electric vehicle (PHEV), a battery electric vehicle (BEV), or a fuel cell electric vehicle (FCEV). The power storage apparatus 3 is mounted in a lower portion of the body 2.

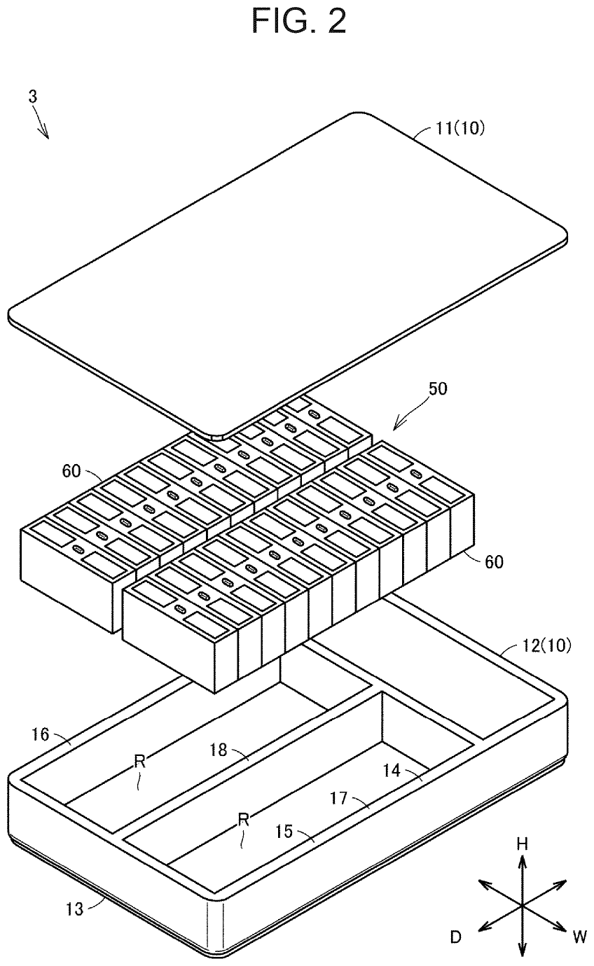

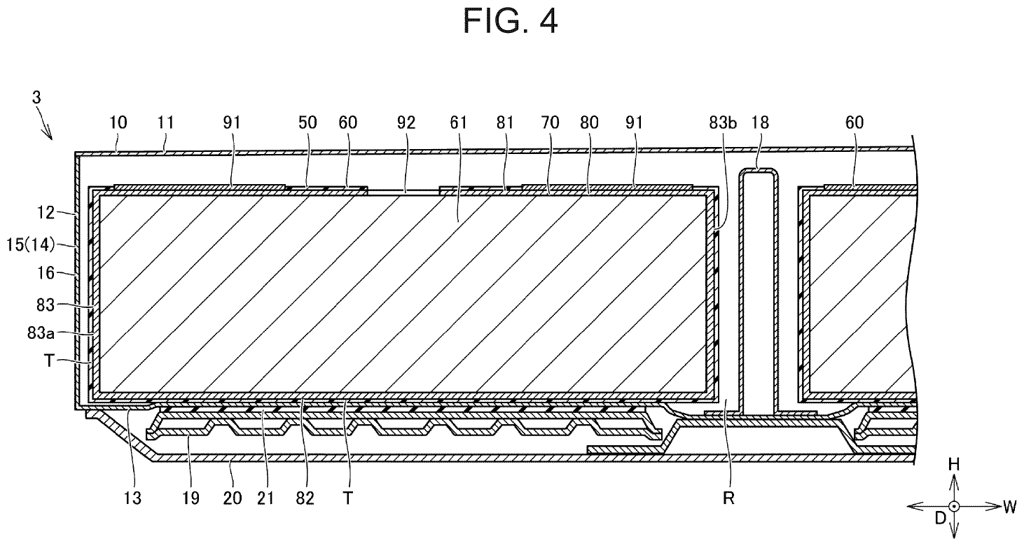

FIG. 2 is an exploded perspective view of a power storage apparatus in an embodiment of the present disclosure. The power storage apparatus 3 includes a housing case 10, a power storage stack 50, and a cooler 19 shown in FIG. 4.

The housing case 10 includes an upper cover 11 and a lower case 12. The housing case 10 forms a housing space R defined by the upper cover 11 and the lower case 12.

The upper cover 11 is formed to cover the lower case 12 formed to open upward.

The lower case 12 includes a bottom plate 13 and a wall portion 14. The bottom plate 13 supports the power storage stack 50 in the height direction H.

The wall portion 14 is formed to stand upward from the bottom plate 13 in the height direction H. The wall portion 14 has a circumferential wall 15 and a reinforcement portion 18. The circumferential wall 15 is formed to extend annularly, and is formed to extend upward from the outer peripheral edge portion of the bottom plate 13 in the height direction H. The circumferential wall 15 has a first lateral wall 16 and a second lateral wall 17. The first lateral wall 16 and the second lateral wall 17 are formed to extend in the front-rear direction D, and are arranged to be spaced from each other in the width direction W.

The reinforcement portion 18 is formed to extend in the front-rear direction D. The reinforcement portion 18 is arranged to pass through the center of the first lateral wall 16 and the second lateral wall 17 in the width direction W.

The power storage stack 50 is housed in the housing space R. The power storage stack 50 is constituted of a plurality of power storage cells 60. The power storage cells 60 are arranged in the front-rear direction D. Each of the power storage cells 60 is formed into a rectangular solid shape that is formed to be long in the width direction W.

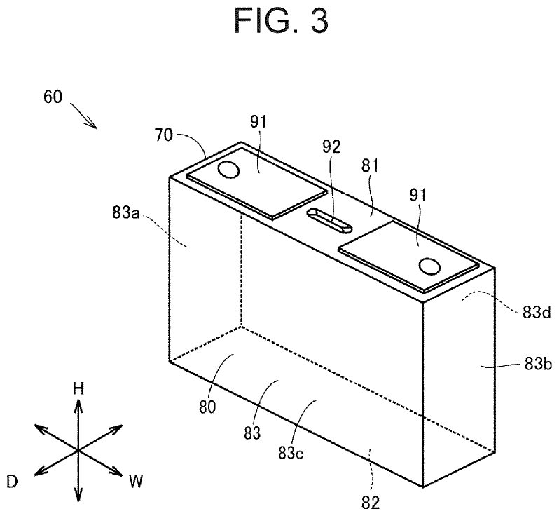

FIG. 3 is a perspective view of the power storage cell 60 in an embodiment of the present disclosure. Each of the power storage cells 60 has a cell case 70, external terminals 91, and an exhaust valve 92.

The cell case 70 is formed into a rectangular solid. The cell case 70 includes metal such as aluminum. The cell case 70 has an outer surface 80. The outer surface 80 has a first end surface 81, a second end surface 82, and a peripheral surface 83. The first end surface 81 and the second end surface 82 are arranged to be spaced from each other in the height direction H. The second end surface 82 is arranged to be closer to the bottom plate 13 than the first end surface 81. The second end surface 82 is a surface facing the bottom plate 13.

The peripheral surface 83 is formed to connect the first end surface 81 and the second end surface 82. The peripheral surface 83 has a first lateral surface 83a, a second lateral surface 83b, a first long surface 83c, and a second long surface 83d. The first lateral surface 83a and the second lateral surface 83b are arranged to be spaced from each other in the width direction W. The first long surface 83c and the second long surface 83d are arranged to be spaced from each other in the front-rear direction D. The first long surface 83c is formed to extend in the width direction W and to connect one end of the first lateral surface 83a and one end of the second lateral surface 83b. The second long surface 83d is formed to extend in the width direction W and to connect another end of the first lateral surface 83a and another end of the second lateral surface 83b. In the power storage stack 50, at least one of the first long surface 83c and the second long surface 83d of each of the power storage cells 60 faces adjacent one of the power storage cells 60.

The external terminals 91 and the exhaust valve 92 are provided on the first end surface 81. The exhaust valve 92 opens when a pressure of gas in the cell case 70 becomes not less than a certain value. Namely, the first end surface 81 on which the exhaust valve 92 is provided constitutes a pressure releasing surface of the cell case 70.

FIG. 4 is a sectional view as the IV-IV section in FIG. 1. The cooler 19 is provided on the bottom plate 13 via a heat conductive material 21. The cooler 19 is disposed on the opposite side of the bottom plate 13 from the power storage cells 60 in the height direction H. The cooler 19 faces the second end surface 82 with the bottom plate 13 being therebetween. In the present embodiment, the cooler 19 cools the power storage cells 60 of the power storage stack 50. A cooling medium (oil or the like) flows in the cooler 19. Notably, the second end surface 82 facing the cooler 19 is an example of a “facing surface” of the present disclosure.

The housing case 10 further has a share panel 20. The share panel 20 is positioned on the opposite side of the bottom plate 13 from the power storage cells 60 in the height direction H. The share panel 20 is provided on the bottom plate 13 with the cooler 19 being therebetween. The share panel 20 has a function of protecting the lower case 12. The share panel 20 may be formed in a flat plate shape.

Each of the power storage cells 60 further has an electrode body 61 housed in the cell case 70, and a heat conductive film T formed on the outer surface 80 of the cell case 70. Notably, the heat conductive film T is formed on the outer surface 80 except on the external terminals 91 and the exhaust valve 92. The heat conductive film T is preferably formed to cover on the whole second end surface 82 and the whole peripheral surface 83 of the power storage cell 60 except on the external terminals 91 and the exhaust valve 92. Thereby, radiation, to the outside, of heat generated from the inside of the housing case 10 can be promoted.

The heat conductive film T has elasticity. A thickness of the heat conductive film T formed on the outer surface 80 is not less than 1 mm and not more than 10 mm. By using such a heat conductive film T, a gap can be restrained from arising between the power storage cell 60 and the bottom plate 13. As a result, heat conduction between the power storage cell 60 and the bottom plate 13 can be restrained from being disturbed due to such a gap. Moreover, the heat conductive film T also functions as an elastic body between adjacent ones of the power storage cells 60. Thereby, as compared with a case of arranging elastic bodies between the power storage cells 60, the number of components of the power storage apparatus 3 can be reduced.

Here, that the heat conductive film T has elasticity means that a measurement method using a type C durometer based on JIS K7312 indicates 5 points or more and a measurement method using a type A durometer based on JIS K6253-3 indicates 50 points or less. The heat conductive film T can accordingly be restrained from being damaged when the power storage cells 60 are assembled into the housing case 10. In addition, the heat conductive film T can restrain close contact of the power storage cell 60 with an adjacent component of the power storage cell 60 from being disturbed.

A heat conductivity of the heat conductive film T is not less than 1.0 W/mK and not more than 30.0 W/mK. By using such a heat conductive film T, even when a heat conductive material is not interposed between the power storage cell 60 and the bottom plate 13, heat conduction between the power storage cell 60 and the bottom plate 13 can be restrained from being disturbed. As a result, the number of components of the power storage apparatus 3 can be reduced. The heat conductive film T may contain an insulating filler material. The insulating filler material includes a material of an inorganic compound or the like. More in detail, the insulating filler material includes a material of a silicon compound such as fused silica, a metal oxide of alumina, magnesium, or the like, a nitrogen compound such as boron nitride or aluminum nitride, or the like. By the heat conductive film T containing the insulating filler material, heat conduction of the heat conductive film T can be improved.

The heat conductive film T has insulation. A dielectric breakdown voltage of the heat conductive film T is not less than 5 kV/mm and not more than 30 kV/mm. Moreover, a volume resistivity of the heat conductive film T is not less than 1.0×10¹⁰ Ω·cm and not more than 1.0×10¹⁷ Ω·cm. By using such a heat conductive film T, the power storage cell 60 can be restrained from conducting electricity with adjacent one of the power storage cells 60 or the like.

After being hardened, the heat conductive film T covers the cell case 70. For example, the heat conductive film T is bonded to the cell case 70 through its hardening process. After being hardened, the heat conductive film T does not have adhesion. Namely, the power storage cells 60 housed in the housing space R do not adhere to the bottom plate 13. By using such a heat conductive film T, the power storage cells 60 can be easily released from the power storage apparatus 3. Moreover, the heat conductive film T does not have to be bonded to the cell case 70. Thereby, the heat conductive film T can be easily peeled off from the cell case 70.

A material forming the heat conductive film T is in the form of paste when not being hardened. The material forming the heat conductive film T preferably has thixotropy when not being hardened. The material forming the heat conductive film T is a hardening liquid material. For example, the hardening liquid material is a single-component or two-component potting material, or gap filler. The material forming the heat conductive film T is a material that is hardened through any of thermal curing, cold curing, moisture curing, and ultraviolet curing. The material forming the heat conductive film T has a base resin of any of a silicone resin, an epoxy resin, and a urethane resin. By forming the heat conductive film T from such a material, a defect and/or damage on the heat conductive film T can be repaired by touch-up. As a result, as compared with replacement of the whole heat conductive film T covering the power storage cell 60, the number of steps required for repairment can be restrained from increasing. Here, the material forming the heat conductive film T when not being hardened has a viscosity not less than 0.1 Pa·s and not more than 500 Pa·s. The heat conductive film T can accordingly be formed on the cell case 70 by coating or dipping. In addition, the film thickness can be restrained from decreasing due to dripping-off or the like during the process of hardening of the heat conductive film T.

While in the aforementioned embodiment, there has been described the example in which the heat conductive film T is formed on the whole outer surface 80, the present disclosure is not limited to this. For example, the first end surface 81 may have no heat conductive film T formed. Otherwise, the heat conductive film T may be formed only on surfaces that are in contact with adjacent ones of the power storage cells 60 and a surface that is in contact with the bottom plate 13, out of the outer surface 80. More specifically, the heat conductive film T may be formed only on the second end surface 82 and at least one of the first long surface 83c and the second long surface 83d. Furthermore, as to surfaces out of the outer surface 80, the surfaces facing adjacent ones of the power storage cells 60, the heat conductive film T may be formed only on a part of the surfaces. By the heat conductive film T being partially formed, gap(s) are formed across toward the adjacent power storage cells. Thereby, spatial insulation is secured, and short circuit between adjacent ones of the power storage cells 60 can be restrained.

In the aforementioned embodiment, the heat conductive film T is formed on the outer surface 80 except on the external terminals 91 and the exhaust valve 92. Thereby, functions of the external terminals 91 and the exhaust valve 92 can be restrained from being impaired due to the cell case 70 being coated with the heat conductive film T.

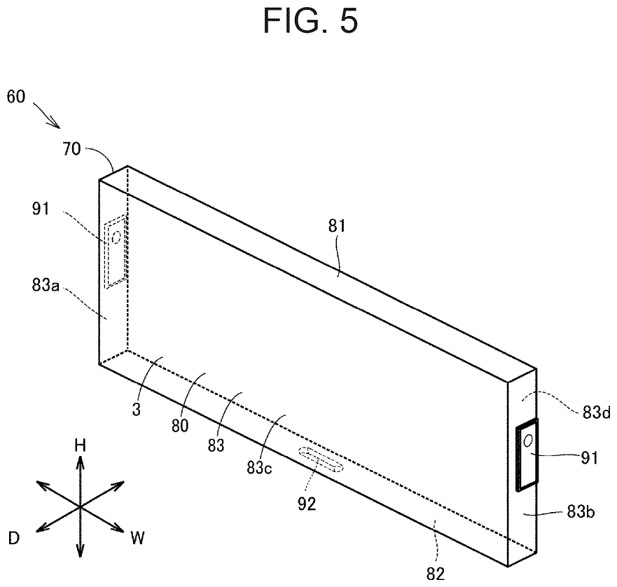

While in the aforementioned embodiment, there has been described the example in which the exhaust valve 92 is provided on the first end surface 81, the present disclosure is not limited to this. For example, as shown in FIG. 5, the exhaust valve 92 may be provided on the second end surface 82.

While in the aforementioned embodiment, there has been described the example in which the external terminals 91 are provided on the first end surface 81, the present disclosure is not limited to this. For example, as shown in FIG. 5, the external terminals 91 may be provided on the first lateral surface 83a and the second lateral surface 83b. Otherwise, the external terminals 91 may be provided only on one of the first lateral surface 83a or the second lateral surface 83b.

### Formation Method of Heat Conductive Film T

Next, an example of a formation method of the heat conductive film T for the power storage cell 60 is described. The formation method of the heat conductive film T includes a preparing step, a curing step, a coating step, and a drying step in the order of the steps. Details of the steps are hereafter described.

In the preparing step, the power storage cell 60 before the heat conductive film T is formed is prepared. In the curing step, the external terminals 91 and the exhaust valve 92 of the power storage cell 60 prepared in the preparing step are masked. Moreover, in the preparing step, the insulating filler is input into and well mixed with an unhardened material for the heat conductive film T. In the coating step, the power storage cell 60 is coated with the material for the heat conductive film T. The coating is performed as dipping or coating. In the drying step, the material for the heat conductive film T thus coated is dried, and the heat conductive film T is hardened. Through the above steps, the heat conductive film T is formed on the outer surface 80 of the power storage cell 60.

It should be construed that the embodiments disclose here are exemplary and not restrictive in all respects. The scope of the present disclosure is indicated by the claims, not by the aforementioned description of the embodiments, and it is intended to include all alterations within the scope and sprit of the claims and equivalents.

What is claimed is:

1. A power storage cell comprising:
an electrode body;
a cell case housing the electrode body; and
a heat conductive film provided on an outer surface of the cell case, wherein:
the outer surface includes a facing surface that faces a cooler that is externally provided; and
the heat conductive film is provided on the facing surface and has elasticity and insulation.

2. The power storage cell according to claim 1, wherein the elasticity of the heat conductive film is indicated as 5 points or more with a type C durometer and as 50 points or less with a type A durometer, and a dielectric breakdown voltage of the heat conductive film is not less than 5 kV/mm and not more than 30 kV/mm.

3. The power storage cell according to claim 1, wherein the heat conductive film contains an insulating filler material.

4. The power storage cell according to claim 1, wherein:
the power storage cell is housed in a power storage apparatus;
the power storage apparatus includes
a housing case, and
the cooler;
the housing case includes
an upper cover, and
a lower case;
the lower case has
a bottom plate, and
a wall portion provided to stand from the bottom plate in a first direction;
the bottom plate supports the power storage cell in the first direction; and
the cooler is provided on the bottom plate and is disposed on an opposite side of the bottom plate from the power storage cell in the first direction.

5. The power storage cell according to claim 1, further comprising:
an exhaust valve; and
an external terminal, wherein:
the outer surface has
an end surface disposed to be spaced from the facing surface in the first direction, and
a peripheral surface connecting the facing surface and the end surface;
the peripheral surface has
a first lateral surface, and
a second lateral surface disposed to be spaced from the first lateral surface in a second direction intersecting the first direction;
the exhaust valve is provided on the outer surface;
the external terminal is provided on at least one of the first lateral surface and the second lateral surface; and
the heat conductive film is provided except on the external terminal and the exhaust valve.
